(19) United States
(12) Patent Application Publication
(10) Pub. No.: US 2026/0160108 A1
(43) Pub. Date: Jun. 11, 2026

(54) ADJUSTING DEVICE

(71) Applicant: Stabilus GmbH, Koblenz (DE)

(72) Inventors: Jonathan Keßler, Gemünden (DE); Christian Einig, Brohl (DE)

(21) Appl. No.: 19/409,834

(22) Filed: Dec. 5, 2025

(30) Foreign Application Priority Data
Dec. 10, 2024 (DE) 102024137012.2

(51) Int. Cl. E05F 15/616

(52) U.S. Cl. CPC E05F 15/616

(57) ABSTRACT

The invention relates to an adjusting device (10) for a vehicle part that is movable relative to a body of a vehicle, in particular for a vehicle door or a vehicle flap, comprising:

a housing (16) arranged on the movable vehicle part or on the body, a drive assembly (12) having a drive unit (14),

an adjusting element (18) that is designed to be displaceable, by means of the drive unit (14), along a displacement axis relative to the drive assembly (12) and has, at a free end, a joint bearing (19) designed to be arranged on a body of the vehicle or on the movable vehicle part, wherein the adjusting element (18) extends through an opening (44) between a vehicle cavity (40) and a cavity (42) of the movable vehicle part that accommodates the adjusting device (10),

a sealing element (38) that is sealingly arranged on the adjusting element (18) and is designed to seal the opening

According to the invention, the sealing element (38) has at least a first partial body (50) and a second partial body (54) that is connected to the first partial body via an inner body (52), wherein the first partial body (50) is designed such that the sealing element (38) is centerable, at least in a closed position of the movable vehicle part, on the housing (16) of the adjusting device (10), and wherein the second partial body (54) is designed for sealing fastening to the adjusting element (28).

The invention relates to an adjusting device for a vehicle part that is movable relative to a body of a vehicle, in particular for a vehicle door or a vehicle flap, according to the preamble of claim 1. The invention further relates to a vehicle having an adjusting device.

An adjusting device of the type mentioned above is known, for example, from WO 2024/193761 A1. The adjusting device described therein comprises a sealing element for sealing an opening connecting two cavities.

To reliably prevent water from passing between the cavities, a minimum overlap of the opening is necessary, at least when the movable vehicle part is closed. Tolerances that occur during the production of the adjusting device, as well as during installation, must be taken into account. At the same time, the possible sealing area around the opening is limited, because fastening elements required for the adjusting device are arranged in the region of the opening and at least parts of the fastening elements (e.g., a stud and associated nuts) protrude into the vehicle cavity. Adverse tolerance chains can therefore lead to an overlap of the fastening elements, which means that a reliable seal can no longer be ensured. Over time, the overlap can also result in damage to the sealing element.

Against this background, the object of the invention is to provide an improved adjusting device with regard to sealing for a vehicle part that is movable relative to the body of a vehicle. It is also an object of the invention to specify a vehicle comprising such an adjusting device.

According to the invention, this object is achieved with regard to the adjusting device by the subject matter of claim 1 and, with regard to the vehicle, by the subject matter of claim 10.

In particular, the object is achieved by an adjusting device for a vehicle part that is movable relative to a body of a vehicle, in particular for a vehicle door or a vehicle flap, comprising a housing arranged on the movable vehicle part or on the body, a drive assembly with a drive unit, and an adjusting element that is designed to be displaceable, by means of the drive unit, along a displacement axis relative to the drive assembly and has, at a free end, a joint bearing end designed to be arranged on a body of the vehicle or on the movable vehicle part.

The adjusting element protrudes through an opening between a vehicle cavity and a cavity in the movable vehicle part that accommodates the adjusting device.

Furthermore, the adjusting device comprises a sealing element that is arranged sealingly on the adjusting element and is designed to seal the opening.

According to the invention, the sealing element has at least a first partial body and a second partial body that is connected to the first partial body via an inner body, wherein the first partial body is designed such that the sealing element is centerable, at least in a closed position of the movable vehicle part, on the housing of the adjusting device, and wherein the second partial body is designed for sealing fastening to the adjusting element.

The centering of the sealing element allows for precise positioning on the sealing surface with respect to the opening, so that an offset of the sealing element and a corresponding overlap with the fastening elements can be excluded.

In a preferred embodiment of the invention, the sealing element has, on an outer side of the first partial body, a centering collar for sealing on a side of the vehicle cavity facing away from the adjusting device. The centering collar is arranged, in particular, on a partial body end of the first partial body facing away from the adjusting device and allows simplified installation of the sealing element fastened to the adjusting element through the opening. By designing the centering collar as a sealing lip, reliable sealing of the sealing surface formed around the opening can be ensured.

At the same time, the centering collar prevents the sealing element from being turned inside out during movement of the adjusting element.

Preferably, the first partial body is cup-shaped and a partial body end facing the adjusting device is insertable into a pocket-shaped recess of the housing and is seatable against a bottom of the recess. This means that, at least when the movable vehicle part is in a closed position, the sealing element protrudes only partially into the vehicle cavity. The required installation space can be reduced in this way.

The pocket-shaped recess also allows for very easy guidance and centering of the sealing element.

Preferably, the pocket-shaped recess can be formed in a cover of the housing. The cover can, in particular, be formed from plastics material, so that the recess is easy to produce. This makes it possible to standardize the sealing element for different embodiments of the adjusting drive, since it is only necessary to adapt the cover to the vehicle and the corresponding adjusting drive.

Improved tolerance compensation in the x, y and z directions can be made possible in that the inner body is formed in a disk-spring-like manner and connects the partial body end facing the adjusting device to the second partial body. The first partial body and the centering collar can thereby always bear with the same preload as soon as the partial body end comes to bear against the bottom of the pocket-shaped recess.

The fastening of the sealing element can be configured in a simple manner in that the sealing element completely surrounds the adjusting element and is fastenable to the adjusting element by means of a latching connection. Other fastening types are conceivable within the scope of the invention.

Preferably, the adjusting device is designed as an electrical spindle drive.

The adjusting device can have a slide assembly that is movable, by means of a drive unit, along a rotation axis of a spindle between a first position and a second position, wherein the adjusting element is connected at one end to the slide assembly. Furthermore, the slide assembly can comprise a spindle nut that is in threaded engagement with the spindle.

A coordinate aspect of the invention relates to a vehicle comprising an above-described adjusting device. The present invention relates to an adjusting device for a vehicle part that is movable relative to a body of a vehicle, in particular for a vehicle door or a vehicle flap.

The present invention will be described below with reference to an embodiment. In the drawings:

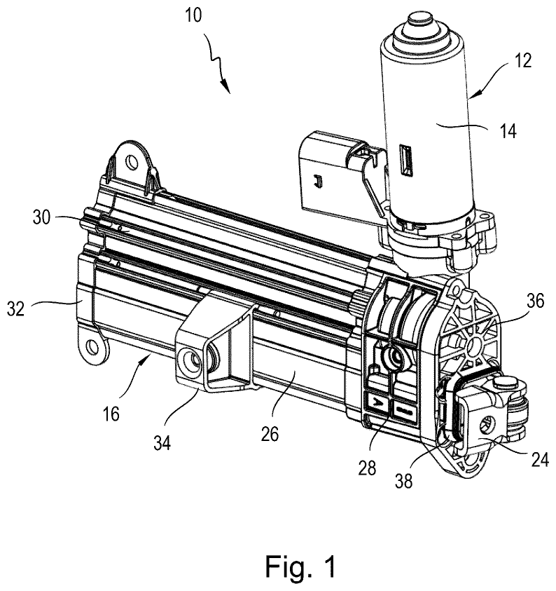

FIG. 1 depicts a spatial representation of an adjusting device according to the invention;

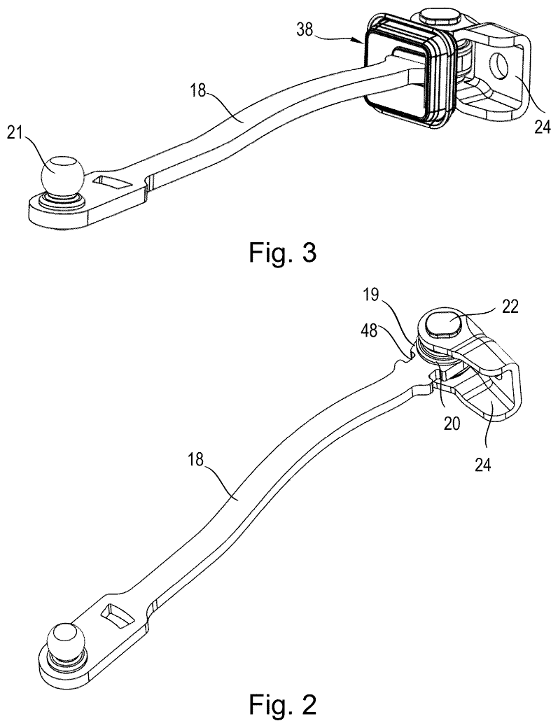

FIG. 2 depicts a spatial representation of an adjusting element of the adjusting device according to the invention of FIG. 1;

FIG. 3 depicts a spatial representation of the adjusting element from FIG. 2 with a mounted sealing element;

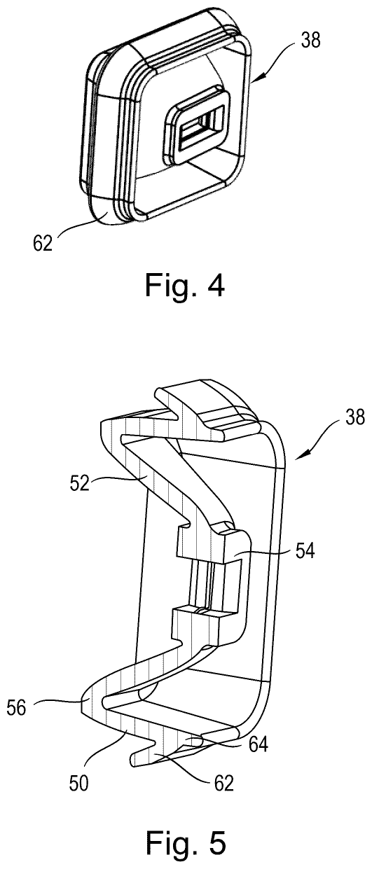

FIG. 4 depicts a spatial representation of the sealing element of FIG. 3;

FIG. 5 depicts a spatial sectional representation of the sealing element of FIGS. 3 and 4;

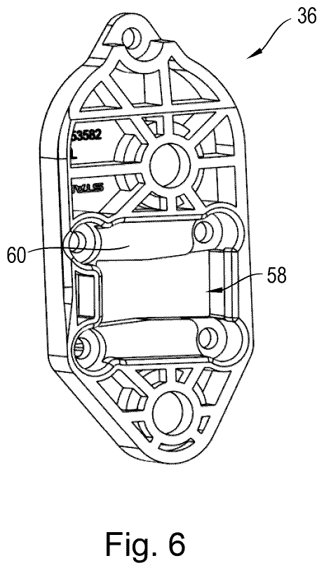

FIG. 6 depicts a spatial representation of a cover of the adjusting device of FIG. 1;

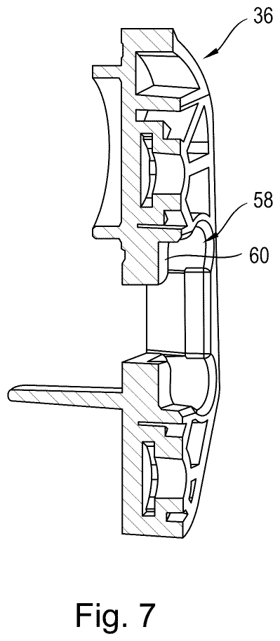

FIG. 7 depicts a spatial sectional representation of the cover of FIG. 6 and

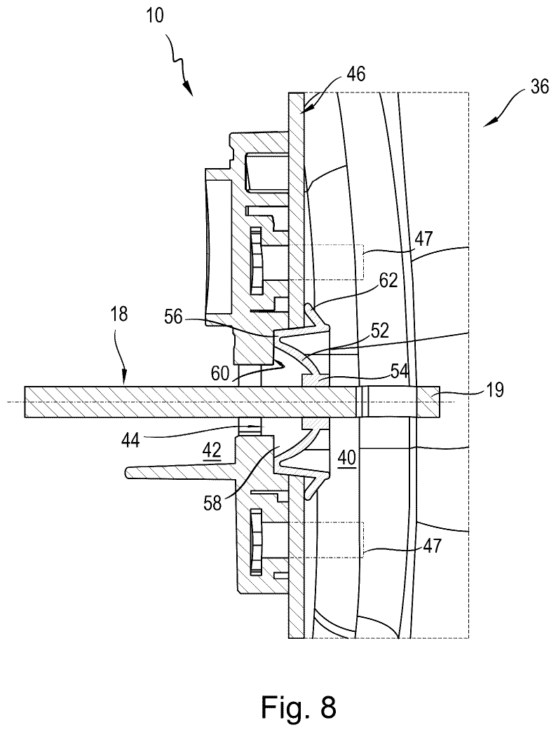

FIG. 8 depicts a cross section of the adjusting element with the mounted sealing element in a closed position of the movable vehicle part.

In FIG. 1, an adjusting device according to the invention is generally denoted by reference sign 10. The adjusting device 10 is designed, by way of example, as an electrical spindle drive. Such an adjusting device is disclosed in the aforementioned earlier application of the applicant WO 2024/193761 A1, which is fully incorporated into the disclosure content of the present application.

The adjusting device comprises a drive assembly 12 having a drive unit 14 and a drive element (not shown) driven by the drive unit 14, which can, for example, be implemented as a worm that is rotationally driven by the drive unit 14 implemented as an electric motor and meshes with a worm wheel. The worm wheel is fixedly arranged on a spindle so that rotation of the drive element causes rotation of the worm wheel and thus of the spindle. The drive element can be formed in one piece with a motor shaft of the drive unit 14 or, alternatively, can be connected thereto.

The spindle is in threaded engagement with a spindle nut, wherein the spindle nut is arranged in a rotationally secured manner relative to a housing 16 of the adjusting device 10 and is thus displaceable axially along a rotational axis of the spindle upon rotation of the spindle.

The spindle nut is preferably part of a slide assembly, which, together with the spindle nut, can be displaced along the rotational axis of the spindle upon rotation of the spindle. The slide assembly is connected to an adjusting element 18, which is shown in a perspective representation in FIGS. 2 and 3 and is designed here as an S-shaped door check strap, wherein the S-shape extends substantially in a plane that is aligned parallel to the rotation axis R of the spindle 20 and orthogonal to the plane of the sheet of FIG. 1. Alternatively, the adjusting element 18 could also be straight.

In the embodiment shown, the adjusting element 18 has a rectangular cross section. Alternatively, it may also be round or approximately oval.

The adjusting element 18 is connected at its free end (shown on the right in FIGS. 2 and 3) to a movable vehicle part, such as a side door of a vehicle (not shown), or alternatively to a vehicle body (not shown).

To this end, the adjusting element 18 has a joint bearing 19 having a one-piece or multi-part joint bearing insert 20, wherein the joint bearing is connected, by means of a joint bolt 22, to a retaining plate 24.

For fastening, the retaining plate 24 (also called angle plate) is fastened to the vehicle (vehicle door or body). Twisted fastening of the retaining plate 22 affects the coordinated movement geometries and leads to a misalignment of the system. In order to avoid complex mounting of the retaining plate 24 by means of a template, angular errors in the region of the joint bearing 19 can be compensated so that this error does not have any further effect on the subsequent system.

At its end opposite the free end, shown on the left in FIGS. 2 and 3, the adjusting element 18 is articulated to the slide assembly by means of a joint head 21, so that a pivoting movement of the adjusting element 18 with respect to the slide assembly is made possible.

Upon activation of the drive unit 14, the spindle is thus set in rotation, whereby the adjusting element 18 is displaced via the slide assembly along a displacement axis, which in a neutral position of the adjusting element 18 and the slide assembly coincides with a central axis of the straight adjusting element 18.

In order to allow a certain upward and downward movement of the free end of the adjusting element 18, the slide assembly and the spindle nut are tiltable relative to one another or rotatable to a limited extent.

The adjusting device 10 shown is in particular intended for mounting on the movable vehicle part. In the exemplary embodiment shown, the drive assembly 12 is arranged on a front side of the adjusting device 10, wherein the front side is understood to be a side of the adjusting device 10 facing the free end of the adjusting element 18. However, due to the limited installation space on the movable vehicle part, it may be advantageous to provide a reverse arrangement of the drive assembly 12. In other words, it may be advantageous due to installation space constraints to arrange the drive assembly 12 on a rear side of the adjusting device 10 facing away from the free end of the adjusting element 18. A further advantage of this reverse arrangement of the drive assembly 12 is the resulting possibility of designing the adjusting device 10 in a simple manner in the same construction for both sides of the vehicle, i.e., for the left and the right vehicle sides. It is only necessary to tilt the assembly by 180°.

The basic structure and function of these two embodiments, which differ in the arrangement of the drive unit 12, are basically identical.

In order to ensure that, even in the installed state, the adjusting device 10 can be clearly identified, for example by a workshop employee, without having to remove it from the vehicle or the side door, a suitable marking of the adjusting device 10 can be provided. However, since these markings should not be visible to an end customer/driver of the vehicle, the adjusting element 18 can advantageously be labeled on a side wall that, in the installed state, faces away from the passenger compartment of the vehicle. In the installed state, this side wall of the adjusting element 18 faces, for example, the side door and is not visible to an end customer of the vehicle. If the adjusting device 10 is arranged, tilted by 180°, on the other vehicle side, the marking is also located on the side wall of the adjusting element 18 that faces away from the passenger compartment.

As an alternative labeling method, it is conceivable to label the adjusting element 18 by means of a suitable lacquer, which can only be made visible when using a suitable light source. For example, a UV varnish can be used, which only becomes visible with the aid of a UV lamp.

The housing 16 of the adjusting device 10 is designed in multiple parts and has a first housing part 26 and a second housing part 28. The first housing part 26 is, by way of example, a profile tube made of aluminum having an open profile structure and a plurality of longitudinal grooves 28 distributed around its circumference.

The longitudinal grooves 30 serve to easily fasten a first cover 32 that seals the profile tube. Furthermore, a fastening element 34 can, by means of the longitudinal grooves 30, be attached to the profile tube, which provides a further, additional fastening point for the adjusting device 10. The fastening element 34 is, by means of a frictional and/or form-fitting connection, fastenable to the first housing part 26 in a variable position along the longitudinal grooves 30 and allows for an additional fastening point that is flexibly adaptable to the installation space.

As can be seen from FIG. 1, the drive unit 14, preferably designed as an electric motor, is flanged to the second housing part 28, in which the gear unit, consisting at least of a worm and worm wheel, is arranged. The second housing part 28 is preferably formed from plastics material and is closed by means of a second cover 36, which is shown in FIGS. 6 and 7. The adjusting element 18 protrudes through the second cover 36 for adjusting the movable vehicle part, for example the vehicle door. FIG. 1 shows the adjusting device 10 in an end position in which the adjusting element 18 is completely retracted and the vehicle door is closed. The covers 32 and 36 are likewise formed from plastics material.

By means of the second cover 36, the adjusting device 10 is fastened to a hinge carrier plate 46 of the vehicle door. Fastening elements 47, indicated only by a dashed line, protrude through the hinge carrier plate 46 in the direction of a vehicle cavity 40 that accommodates the joint bearing 19, which vehicle cavity is connected by an opening 44 to a cavity 42 of the vehicle door that accommodates the adjusting device 10.

The size of the opening 44, which represents a door opening, is determined by the vehicle manufacturer and is based on the retaining plates that are customary in the automotive industry. The spacing of the fastening elements 47 is generally specified as a standard dimension.

FIGS. 4 and 5 are perspective representations of a sealing element 38 that is arranged sealingly on the adjusting element 18. FIG. 3 is a perspective representation of the adjusting element 18 with the sealing element 38 arranged sealingly thereon. Said sealing element preferably completely surrounds the adjusting element 18 and is fastened to the adjusting element 18, for example, by means of a latching connection. For fastening, the adjusting element 18 can have two lateral engagement grooves 48 into which the sealing element 38 engages in a latching manner for fastening. Alternative fastening methods are conceivable within the scope of the invention.

The sealing element 38 serves to seal the opening 44 between the two cavities 40, 42, wherein the opening 44 is traversed by the adjusting element 18 during movement of said adjusting element. In particular, in the retracted end position of the adjusting device 10, a seal between the cavities 40, 42 is desired and water penetration should be prevented.

For improved sealing, the sealing element 38 has at least a first partial body 50 and a second partial body 54 that is connected to the first partial body via an inner part 52. The first partial body 50 is designed such that the sealing element 38 is centerable, at least in a closed position of the movable vehicle part, on the housing 16 or on the second cover 36 of the adjusting device 10.

The second partial body 54, clearly visible in FIGS. 4 and 5, is designed for sealingly fastening to the adjusting element 18 and is latchable, for example, into the engagement grooves 48 of the adjusting element 18 described above.

The centering of the sealing element 38 is achieved, in particular, by means of the cup-shaped first partial body 50, which is insertable with one partial body end 56 facing the adjusting device 10 into a pocket-shaped recess 58 of the housing 16 or of the second cover 36 and, in the retracted end position of the adjusting device 10, is seatable against a bottom 60 of the recess 58 with a predetermined preload. In this position, the sealing element 38 protrudes at least partially into the vehicle cavity 40. The required installation space can be reduced in this way.

The guidance and centering of the sealing element 38, which can be achieved particularly easily, in particular by means of the pocket-shaped recess 58, allows the sealing element 38 to be positioned precisely on the sealing surface with respect to the opening, so that an offset of the sealing element 38 and a corresponding overlap with the fastening elements 47 (in particular nuts not shown) extending into the vehicle cavity 40 can be excluded.

Furthermore, the sealing element 38 has a centering collar 62 on an outer side of the first partial body 50, which centering collar is designed, in particular, as a sealing lip and, in a retracted end position of the adjusting device 10, comes to bear sealingly against the hinge carrier plate 46. The centering collar 62 is arranged, in particular, on a partial body end 64 of the first partial body 50 facing away from the adjusting device 10 and allows simplified installation of the sealing element 38 fastened to the adjusting element 18 through the opening 44. By designing the centering collar 62 as a sealing lip, reliable sealing of the sealing surface formed around the opening can be ensured. The sealing contact pressure is independent of vehicle tolerances and the retracted position of the adjusting element 18, since the partial body end 56 facing the adjusting device 10 always comes into contact with the bottom 60 with a predetermined preload. The centering collar 62 likewise always bears with the same preload.

The sealing element 38 and the pocket-shaped recess 58 of the cover 36 allow, in particular, improved tolerance compensation in the x, y and z directions, because the inner body 52 is formed in a disk-spring-like manner and connects the partial body end 56 facing the adjusting device 10 to the second partial body 54. This ensures that the centering collar 62 always bears against the hinge carrier plate 46 with the same preload as soon as contact is made with the bottom 60 of the pocket-shaped recess 48.

The adjusting device 10 is described as an electrical spindle drive. However, the invention is not limited thereto and can likewise be applied to other adjusting devices for a movable vehicle part.

1. Adjusting device for a vehicle part that is movable relative to a body of a vehicle, comprising:
a housing arranged on the movable vehicle part or on the body;
a drive assembly having a drive unit;
an adjusting element that is configured to be displaceable, by means of the drive unit, along a displacement axis relative to the drive assembly and has, at a free end, a joint bearing configured to be arranged on a body of the vehicle or on the movable vehicle part, wherein the adjusting element extends through an opening between a vehicle cavity and a cavity of the movable vehicle part that accommodates the adjusting device; and
a sealing element that is sealingly arranged on the adjusting element and is designed to seal the opening,
wherein the sealing element has at least a first partial body and a second partial body that is connected to the first partial body via an inner body, wherein the first partial body is designed such that the sealing element is centerable, at least in a closed position of the movable vehicle part, on the housing of the adjusting device, and wherein the second partial body is designed for sealing fastening to the adjusting element.

2. Adjusting device according to claim 1, wherein the sealing element has, on an outer side of the first partial body, a centering collar for sealing on a side of the vehicle cavity facing away from the adjusting device.

3. Adjusting device according to claim 1, wherein the first partial body is cup-shaped and a partial body end facing the adjusting device is insertable into a pocket-shaped recess of the housing and is seatable against a bottom of the recess.

4. Adjusting device according to claim 3, wherein the pocket-shaped recess is formed in a cover of the housing.

5. Adjusting device according to claim 3, wherein the inner body is formed in a disk-spring-like manner and connects the partial body end facing the adjusting device to the second partial body.

6. Adjusting device according to claim 1, wherein the sealing element completely surrounds the adjusting element and can be fastened to the adjusting element by means of a latching connection.

7. Adjusting device according to claim 1, wherein the adjusting device is designed as an electrical spindle drive.

8. Adjusting device according to claim 7, wherein a slide assembly is provided that is movable, by means of a drive unit, along a rotation axis of a spindle between a first position and a second position, wherein the adjusting element is connected at one end to the slide assembly.

9. Adjusting device according to claim 8, wherein the slide assembly comprises a spindle nut, which is in threaded engagement with the spindle.

10. Vehicle with an adjusting device for a vehicle part that is movable relative to the body of the vehicle according to claim 1.
